(19) United States
(12) Patent Application Publication
(10) Pub. No.: US 2024/0060435 A1
(43) Pub. Date: Feb. 22, 2024

(54) OIL FILTER ASSEMBLY

(71) Applicant: RB Distribution, Inc., Colmar, PA (US)

(72) Inventors: Andrew Setz KELLY, Philadelphia, PA (US); Evan SODA, Perkiomenville, PA (US); Gabriel KOVACS, Abington, PA (US); Robert PISCH, Willow Grove, PA (US); Eric TRYSON, Willow Grove, PA (US)

(73) Assignee: RB Distribution, Inc., Colmar, PA (US)

(21) Appl. No.: 18/501,705

(22) Filed: Nov. 3, 2023

Related U.S. Application Data
(63) Continuation of application No. 18/194,343, filed on Mar. 31, 2023.
Application No. 18/194,343 is a continuation of application No. 17/985,565, filed on Nov. 11, 2022, now Pat. No. 11,639,675.
Application No. 17/985,565 is a continuation of application No. 17/528,884, filed on Nov. 17, 2021, now Pat. No. 11,639,674.
Application No. 17/528,884 is a continuation of application No. 17/406,639, filed on Aug. 19, 2021, now Pat. No. 11,635,005.
(60) Provisional application No. 63/068,759, filed on Aug. 21, 2020.

(51) Int. Cl. F01M 11/03

(52) U.S. Cl. CPC F01M 11/03; F01M 2011/033

(57) ABSTRACT

A casted metallic oil filter adaptor that has an entirely internal lubricant flow path and threads for connecting associated components directly to the casted metallic oil filter adaptor.

### CROSS REFERENCE TO RELATED APPLICATIONS

This application is a continuation of U.S. application Ser. No. 18/194,343 filed on Mar. 31, 2023, which is a continuation of U.S. application Ser. No. 17/985,565, which was filed on Nov. 11, 2022 and issued as U.S. Pat. No. 11,639,675 on May 2, 2023; which is a continuation of U.S. application Ser. No. 17/528,884, which was filed on Nov. 17, 2021 and issued as U.S. Pat. No. 11,639,674 on May 2, 2023; which is a continuation of U.S. application Ser. No. 17/406,639, which was filed on Aug. 19, 2021 and issued as U.S. Pat. No. 11,635,005 on Apr. 25, 2023; which claims the benefit of U.S. Provisional Application No. 63/068,759, which was filed on Aug. 21, 2020, each of which is incorporated herein by reference as if fully set forth herein.

### FIELD OF INVENTION

The invention relates generally to the lubrication of mechanical engines that utilize oil as a lubricating fluid that circulates though defined galleries in the engine. More particularly, the invention relates to a lubrication system where the lubricating fluid is routinely passed through a filter element, which is generally replaceable at certain intervals, and potentially and oil cooler. Most particularly, the invention relates to an adaptor for a lubrication system that incorporates the oil filter housing and an oil cooler in an assembly that is often located within the motor valley.

### BACKGROUND

Modern engines, especially though used in motor vehicles, seek to reduce weight and size while maintaining the desired power. As part of the effort to reduce weight, many parts are being made in plastic and many parts are being combined in assemblies to further reduce weight by eliminating individual connection points. While this trend has proven successful in some areas, it has introduced problems where one or more portions of a plastic assembly experience a failure. Under these conditions, it is often necessary to disassemble unrelated parts of the engine in order to gain access to the assembly and make the necessary repairs.

Another drawback to plastic assemblies is the need to made accommodations for various sensors and system components that need to be connected to the assembly. These connections are most often achieved by molding an opening in the plastic component and attaching a metallic insert to achieve the connection. This plastic to metal connection can be difficult to properly seal. An addition failure point of this metal-plastic connector is the possibility of over tightening the inserted component, such as a sensor fitting or cap, and stressing or damaging the surrounding plastic.

In addition to the above associated with a hybrid plastic-metallic assembly, the molding process requires certain concessions in order to permit molding cores to be inserted and removed during the molding process. An associated drawback with the plastic molding is the need to remove core elements used in the process and reseal the molding which leads to further potential failure points. In addition, the unused molded openings that require closing plugs that must be glued or welded in the unused openings. These plugs represent another failure point in the plastic-metallic assembly.

### SUMMARY

The applicants have discovered that a cast metallic part provides a robust assembly that avoids the needs for inserts, eliminates the need for plugs, and provides for direct threading of components to the adaptor. As a result of eliminating the assembly of multiple molded parts, the performance and durability is improved against burst pressure, heat and age degradation, and conditions related to cycling. In addition, the single metallic casting provides a flow path without the need for adhesives and resealing of the flow path.

### BRIEF DESCRIPTION OF THE DRAWINGS

FIG. 1 is a perspective view of a prior art oil filter adaptor and cooler assembly;

FIG. 2 is a partial rear view of the prior art assembly in FIG. 1;

FIG. 3A illustrates the capping of the oil flow path in the prior art adaptor after removal of the core used in the plastic molding;

FIG. 3B is a section illustrating the flow path in the prior art adaptor;

FIG. 4 is a perspective view of an adaptor according to the invention prior to assembly of any related components;

FIG. 5 is a section view along the line 5-5 in FIG. 4 showing the linear flow path in an adaptor according to the invention; and,

FIG. 6 is a perspective view of an adaptor according to the invention in a direction opposite to that of FIG. 4.

### DETAILED DESCRIPTION

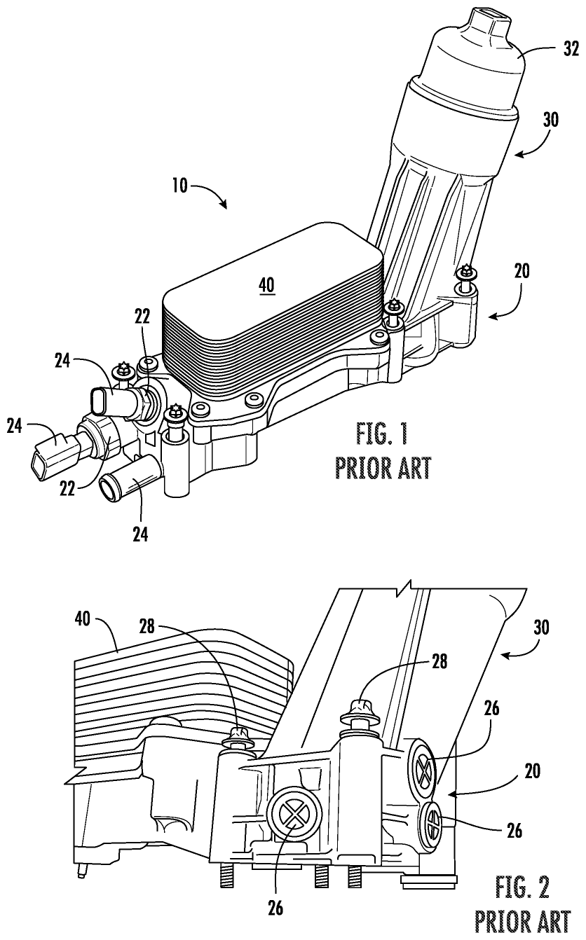

The prior art oil filter assembly shown in FIGS. 1-3B is typical of the adaptor construction resulting from using moldable plastic materials. The prior art assembly 10 in FIG. 1 has a base 20, a filter housing 30 and an oil cooler 40. The base 20 includes medal inserts 22 that are provided in the plastic construction at designated locations for the attachment of other associated components. The metal inserts and associated components are shown in FIG. 1 at 22 and 24 respectively. Although the metal inserts are frequently molded in situ during the molding of the plastic base, they remain a failure point and can result in oil leakage or worse. The metal inserts 22 are also subject to overtightening during attachment of the associated components 24, which can result in stress cracks in the plastic.

As shown in FIG. 2, the base 20, due to the molding process requiring the ability to withdrawal a core, has a number of plugs 26 that are retrofitted after the base 20 is molded. The plugs 26 are assembled to the molded base with an adhesive or spin welding. In either event, the plugs 26 are a failure point in the base 20 that can result in oil leaking or worse.

In addition to the inserts 22 and plugs 26, the base 20 has a number of metal inserts or sleeves, not shown, that are inserted to reinforce the plastic molded apertures for attachment of the various bolts 28 that hold the assembly 10 together. Here again, the inserts or sleeves introduce a potential failure point. Another potential failure point is the attachment of the cap 32 to the plastic filter housing 30. Over tightening of the cap 32 can introduce stress fracture in the threaded housing 30.

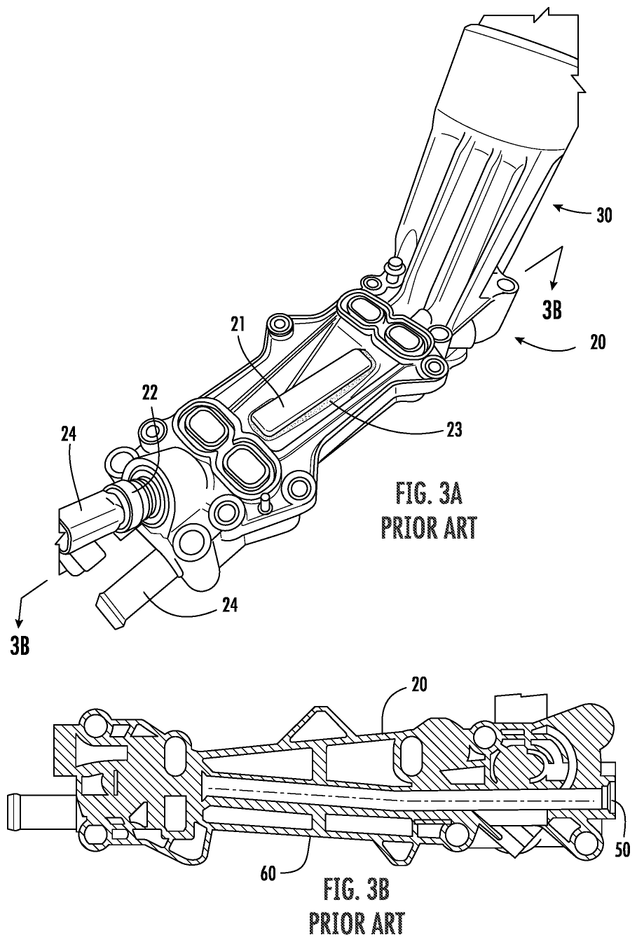

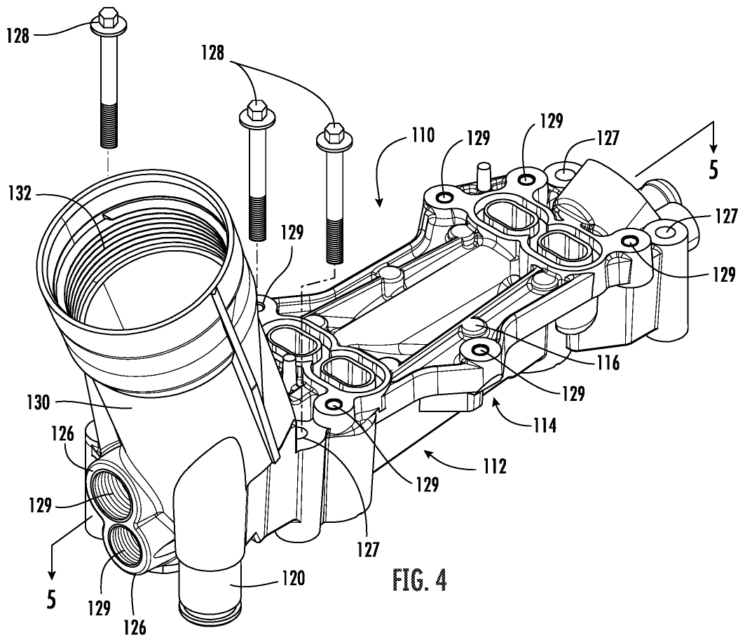

With reference to FIGS. 3A and 3B, it can be seen that the prior art flow path 50 requires a cover 21, at least partially over the flow path, that is adhered to the base after the molding core is removed by the adhesive or welding 23. With reference to FIG. 4B, it can be seen that the flow path 50 bends or is angular; in other word, the flow path 50 does not have a common longitudinal axis.

With reference to FIG. 4, the preferred adaptor 110 has an elongated body 112, which has a lower surface 114 that mates with a lubrication network and an upper surface 116 that mates with a cooling component, a filter housing 130 and base 120 that is formed of a casted metallic material, preferably aluminum. The elongated body 112, base 120 and the filter housing 130 are casted together and the apertures 127 for receiving the bolts 128 do not required metal inserts or sleeves to avoid stressing or cracking do to the solid metallic construction. The casting is also threaded at 129 to receive fasteners for securing an oil cooler 40 and external connectors to the adaptor 110.

Still with reference to FIG. 4, the casted filter housing 130 has internal threaded 132 that mate with an OEM cap 32 to secure a filter within housing 130. In a similar manner, the apertures 126 have internal threading to preferably mate with NPT plugs that are self-sealing. Depending on the type and construction of related components, such as sensors, it may be necessary to employ a gasket or sealing rings with their assembly.

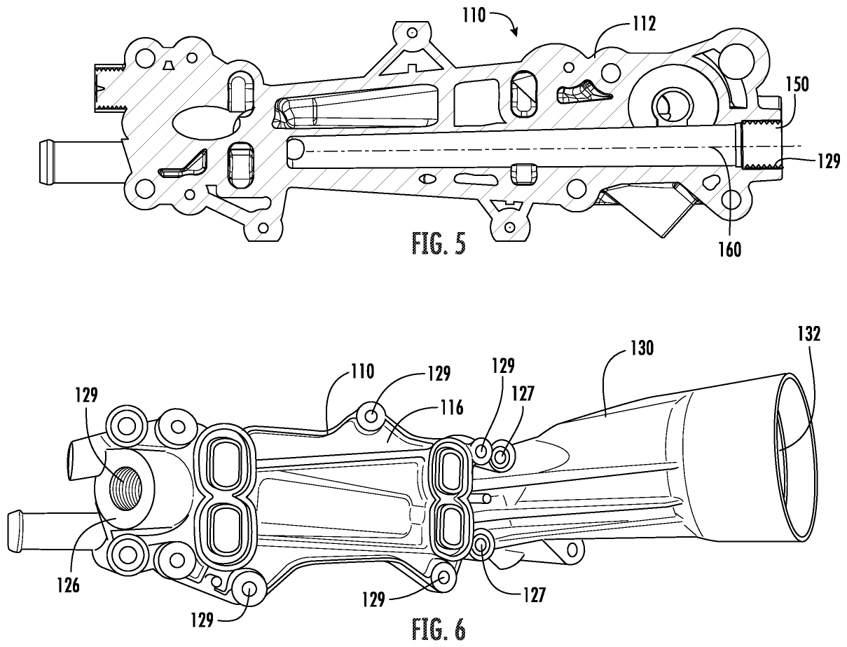

With reference to FIG. 5, the flow path 150 for transporting the lubricant within base 120 to connect with the internal lubrication network is centered about the longitudinal axis 160 and consistent throughout the base 120. The flow path 150 is symmetric about the axis 160 and there is no angular component in the flow path 150 as it is connected with the internal lubrication network. The flow path 150 is entirely within the unitary casting so there is no need for adding a closure to the flow path.

With the exception of the flow path 150, the lubrication galleries and the location positions for associated components are identical to the OEM assembly so the casted metal adaptor is a direct replacement for the OEM part and no modifications or relocations of other components are necessary.

As shown in FIGS. 4 and 6, the adaptor 110, including the filter housing 130 and the base 120 outwardly appearance the same as the OEM part and the base accepts the OEM cooler 40 and the filter housing accepts the cap 32 without any modification.

What is claimed is:

1. A single metallic casted oil filter adaptor for an engine system, comprising:
a base portion of the single metallic casted oil filter adaptor, comprising an input for receiving oil from an oil lubrication network of the engine system and comprising an output for directing oil back to the oil lubrication network of the engine system;
an oil filter housing portion of the single metallic casted oil filter adaptor, comprising threading for mating with a threaded oil filter housing cap;
an elongated body portion of the single metallic casted oil filter adaptor, comprising an upper surface configured to mate with an oil cooling component, comprising one or more first channels configured for a first fluid to traverse the single metallic casted oil filter adaptor, and comprising one or more second channels configured for a second fluid to traverse the single metallic casted oil filter adaptor without mixing with the first fluid, wherein the first fluid comprises oil and the second fluid comprises a coolant;
an internal lubrication flow path channel extending within the elongated body;
a first aperture configured to receive a first sensor;
a second aperture configured to receive a second sensor;
one or more third apertures comprising threading for mating with one or more fasteners for securing the oil cooling component to the upper surface of the elongated body;
wherein the one or more first channels are formed with a fixed opening, the fixed opening configured such that a first portion of the first fluid traverses the elongated body to the oil cooling component, and a remainder of the first fluid traverses the elongated body through the internal lubrication flow path channel,
wherein the internal lubrication flow path channel is formed to allow the remainder of the first fluid to bypass the oil cooling component while the first portion of the first fluid concurrently traverses the oil cooling component,
wherein the first portion of the first fluid and the remainder of the first fluid each consist of less than all of the first fluid entering the single metallic casted adaptor,
wherein the first aperture and the second aperture are in a flow path of the first portion of the first fluid, and
wherein the base portion is configured to:
connect the oil lubrication network of the engine system with an input of the oil filter housing;
connect an oil filter housing output to at least one of the one or more first channels; and
merge the first portion of the first fluid and remainder of the first fluid downstream of the internal lubrication flow path channel before outputting the first fluid through the output to the oil lubrication network of the engine system.

2. A single metallic casted adaptor for an engine system, comprising:
a base portion of the single metallic casted adaptor, configured to connect the single metallic casted adaptor with a lubrication network of the engine system;
a filter housing portion of the single metallic casted adaptor, comprising threading for mating with a filter housing cap;
an elongated body portion of the single metallic casted adaptor, comprising an upper surface configured to mate with a cooling component, comprising one or more first channels configured such that a first fluid traverses the single metallic casted adaptor, and comprising one or more second channels configured such that a second fluid traverses the single metallic casted adaptor without mixing with the first fluid,
wherein the one or more first channels are formed to direct a first portion of the first fluid to the cooling component, and to direct a second portion of the first fluid through an internal lubrication flow path wholly within the single metallic casted adaptor, and
wherein the first portion of the first fluid and the second portion of the first fluid each consist of less than all of the first fluid entering the single metallic casted adaptor.

3. The single metallic casted adaptor of claim 2, wherein the internal lubrication flow path consists of the single metallic casted adaptor.

4. The single metallic casted adaptor of claim 2, wherein the base portion is configured to connect the lubrication network of the engine system with an input of the filter housing and configured to connect an output of the filter housing with the internal lubrication flow path.

5. The single metallic casted adaptor of claim 2, further comprising one or more threaded apertures located on the upper surface of the elongated body, wherein the one or more threaded apertures are configured to receive fasteners for securing the cooling component to the upper surface of the elongated body.

6. The single metallic casted adaptor of claim 2, wherein the internal lubrication flow path is unobstructed.

7. The single metallic casted adaptor of claim 2, further comprising a first aperture located within a flow path of the second portion of the first fluid.

8. The single metallic casted adaptor of claim 7, further comprising a second aperture located within the flow path of the second portion of the first fluid.

9. The single metallic casted adaptor of claim 8, wherein the first and second apertures are casted together with the single metallic casted adaptor.

10. The single metallic casted adaptor of claim 2, wherein the base portion is configured to connect a filter housing output to the lubrication network of the engine system via the internal lubrication flow path.

11. The single metallic casted adaptor of claim 2, wherein the base portion is configured to merge the first portion of the first fluid and the second portion of the first fluid downstream of the internal lubrication flow path before connecting to the lubrication network of the engine system.

12. A single metallic casted adaptor for an engine system, comprising:
a base portion configured to connect the single metallic casted adaptor with a lubrication network of the engine system;
a filter housing portion comprising threading for mating with an externally threaded member;
an elongated body portion comprising an upper surface configured to mate with a cooling component, comprising one or more first channels configured such that a first fluid traverses the single metallic casted adaptor, and comprising one or more second channels configured such that a second fluid traverses the single metallic casted adaptor without mixing with the first fluid;
an internal lubrication flow path extending within the elongated body, formed to allow a first portion of the first fluid to bypass the cooling component while a second portion of the first fluid concurrently traverses the cooling component; and
one or more apertures comprising threading for mating with one or more externally threaded members.

13. The single metallic casted adaptor of claim 12, wherein the internal lubrication flow path consists of the single metallic casted adaptor.

14. The single metallic casted adaptor of claim 12, wherein the externally threaded member comprises an oil filter housing cap.

15. The single metallic casted adaptor of claim 12, wherein the base portion is configured to connect the lubrication network of the engine system with an input of the filter housing portion and configured to connect an output of the filter housing with the internal lubrication flow path.

16. The single metallic casted adaptor of claim 12, wherein the one or more apertures are configured to receive fasteners for securing the cooling component to the upper surface of the elongated body.

17. The single metallic casted adaptor of claim 12, wherein the internal lubrication flow path is formed such that the first portion of the first fluid traverses through the internal lubrication flow path unimpeded.

18. The single metallic casted adaptor of claim 12, wherein the base portion is configured to connect a filter housing output to the lubrication network of the engine system via the internal lubrication flow path.

19. The single metallic casted adaptor of claim 12, wherein one of the one or more apertures is located within a flow path of only the second portion of the first fluid.

20. The single metallic casted adaptor of claim 19, wherein a second of the one or more apertures is located within the flow path of only the second portion of the first fluid.

21. The single metallic casted adaptor of claim 12, wherein the base portion is configured to combine the first portion of the first fluid and the second portion of the first fluid downstream of the internal lubrication flow path before connecting to the lubrication network of the engine system.

22. A single metallic casted adaptor for an engine system, comprising:
a base portion of the single metallic casted adaptor, and configured to connect the single metallic casted adaptor with a lubrication network of the engine system;
a filter housing portion of the single metallic casted adaptor, and comprising threading for mating with an externally threaded member;
an elongated body portion of the single metallic casted adaptor, comprising an upper surface configured to mate with a cooling component, comprising one or more first channels configured such that a first fluid traverses the single metallic casted adaptor, and comprising one or more second channels configured such that a second fluid traverses the single metallic casted adaptor without mixing with the first fluid;
an internal lubrication flow path extending wholly within the elongated body, configured to direct a first portion of the first fluid from the filter housing directly into the lubrication network of the engine system, and
wherein the one or more first channels comprises a fixedly formed opening configured to direct a second portion of the first fluid into the cooling component.

23. The single metallic casted adaptor of claim 22, wherein the internal lubrication flow path consists of the single metallic casted adaptor.

24. The single metallic casted adaptor of claim 22, wherein the base portion is configured to connect the lubrication network of the engine system with an input of the filter housing portion and configured to connect an output of the filter housing portion to the internal lubrication flow path.

25. The single metallic casted adaptor of claim 22, further comprising one or more threaded apertures located on the upper surface of the elongated body, wherein the one or more threaded apertures are configured to receive fasteners for securing the cooling component to the upper surface of the elongated body.

26. The single metallic casted adaptor of claim 22, wherein the internal lubrication flow path is configured such that the first portion of the first fluid traverses through the internal lubrication flow path unimpeded.

27. The single metallic casted adaptor of claim 22, wherein the base portion is configured to connect a filter housing output to the lubrication network of the engine system via the internal lubrication flow path.

28. The single metallic casted adaptor of claim 22, wherein the base portion is configured to combine the first portion of the first fluid and the second portion of the first fluid downstream of the internal lubrication flow path before connecting to the lubrication network of the engine system.

29. The single metallic casted adaptor of claim 22, further comprising a first aperture located within a flow path of the second portion of the first fluid, wherein the first aperture is casted together with the single metallic casted adaptor.

30. The single metallic casted adaptor of claim 29, further comprising a second aperture located within the flow path of the second portion of the first fluid, wherein the second aperture is casted together with the single metallic casted adaptor.
